(19) United States
(12) Patent Application Publication
(10) Pub. No.: US 2010/0164827 A1
(43) Pub. Date: Jul. 1, 2010

(54) DIELECTRIC ANTENNA

(75) Inventors: Tetsuya MIYAGAWA, Nishinomiya-City (JP); Kouji Yano, Nishinomiya-City (JP)

Correspondence Address: BIRCH STEWART KOLASCH & BIRCH, PO BOX 747, FALLS CHURCH, VA, 22040-0747, US

(73) Assignee: Furuno Electric Company, Limited, Nishinomiya-City (JP)

(21) Appl. No.: 12/615,688

(22) Filed: Nov. 10, 2009

(30) Foreign Application Priority Data
Dec. 26, 2008 (JP) 2008-334579

(51) Int. Cl. H01Q 1/36; H01Q 1/00

(52) U.S. Cl. 343/843; 343/700 MS; 343/907

(57) ABSTRACT

This disclosure provides a dielectric antenna including an antenna element for radiating electromagnetic waves at a predetermined frequency in a predetermined direction, and a dielectric member arranged in the radiating direction of the electromagnetic waves radiated from the antenna element. The dielectric member includes two or more dielectric layer portions each extending in a direction perpendicular to the radiating direction of the electromagnetic waves. The two or more dielectric layer portions are arranged at predetermined intervals in the radiating direction of the electromagnetic waves.

### CROSS-REFERENCE TO RELATED APPLICATION(S)

This application claims priority under 35 U.S.C. §119 to Japanese Patent Application No. 2008-334579, which was filed on Dec. 26, 2008, the entire disclosure of which is hereby incorporated by reference.

### TECHNICAL FIELD

The present invention relates to a dielectric antenna in which a dielectric is arranged forward in an electromagnetic wave radiating direction of an antenna in order to acquire desired directivity characteristics.

### BACKGROUND

As technologies to reduce an antenna in thickness and size, a method of forming a beam by arranging a dielectric material forward in an electromagnetic wave radiating direction of the antenna and adjusting the phase of the electromagnetic waves is generally known.

As an example, there is an antenna disclosed in JP3634372(B). In the antenna disclosed in JP3634372(B), as shown in FIG. 7 of JP3634372(B), two or more dielectric layers 20a, 20b, 20c, 20d, and 20e are arranged so as to extend in the radiating direction of electromagnetic waves, and the dielectric layers 20a and 20e which are the outermost layer are provided so as to space from each other by intervals greater than a half-wavelength of the electromagnetic waves radiated from the antenna. Particularly, in the antenna disclosed in JP3634372(B), the dielectric layers 20a, 20b, 20c, 20d, and 20e perform beam forming of the electromagnetic waves radiated from an antenna element to acquiring desired directivity characteristics, while realizing reduction of a height of the antenna compared with other antennas using a horn or the like.

However, when designing a dielectric antenna, in order to form a desired beam pattern, it may be necessary to select a dielectric material having a desired dielectric constant which satisfies the following other designed requirements of the antenna material corresponding to the operating condition of the antenna other than the dielectric constant.

Particularly, the antenna used for radar devices requires at least a high gain, light weight, easy manufacture (processing), and high environmental tolerance. However, there are very few dielectric materials which greatly satisfy these requirements and, thus, it is one of the factors of increasing the cost.

In addition, in the antenna disclosed in JP3634372(B), because the two or more dielectric layers 20a, 20b, 20c, 20d, and 20e need to be arranged so as to space them from each other by the predetermined intervals, support members may be needed between the dielectric layers 20a, 20b, 20c, and 20d and 20e. Therefore, there exist disadvantages on manufacturing, such as a bad manufacturing efficiency.

### SUMMARY

The present invention is made in view of the conditions described above, and provides a dielectric antenna capable of forming a desired beam pattern using a dielectric material that has a low loss, low specific gravity, easy processability, high environmental tolerance, and low cost.

According to an aspect of the invention, a dielectric antenna includes an antenna element for radiating electromagnetic waves at a predetermined frequency in a predetermined direction, and a dielectric member arranged in the radiating direction of the electromagnetic waves radiated from the antenna element. The dielectric member includes two or more dielectric layer portions each extending in a direction perpendicular to the radiating direction of the electromagnetic waves. The two or more dielectric layer portions are arranged at predetermined intervals in the radiating direction of the electromagnetic waves.

The dielectric layer portions may be coupled to each other with coupling portions made of a material similar to that of the dielectric layer portions.

The dielectric member may be formed in a meander shape by coupling the adjacent dielectric layer portions.

The dielectric layer portion may be formed in a plate shape.

The predetermined intervals may be ¼ wavelength or less of the electromagnetic waves radiated from the antenna element.

The dielectric antenna may further include an antenna case made of a dielectric material. Beam forming of the electromagnetic waves radiated from the antenna element may be performed by the two or more dielectric layer portions and the antenna case.

A protrusion may be provided in a face of the antenna case substantially parallel to the radiating direction of the electromagnetic waves.

A dielectric wall may be provided inside the antenna case, substantially parallel to a face of the antenna case at which the electromagnetic waves radiated from the antenna element intersect perpendicularly, and at a position that is separated from the face of the antenna case by substantially ¼ wavelength.

The dielectric antenna may further include a support member for supporting the two or more dielectric layer portions.

According to another aspect of the invention, a dielectric antenna includes an antenna element for radiating electromagnetic waves at a predetermined frequency in a predetermined direction, and a dielectric area where dielectrics are arranged in the radiating direction of the antenna element so as to be spaced from each other at intervals of ¼ wavelength or less of the electromagnetic waves radiated from the antenna element. An effective dielectric constant of the dielectric area that acts on the electromagnetic waves radiated from the antenna is determined based on a dielectric constant of the dielectrics arranged in the dielectric area and a volume of the dielectrics in the dielectric area.

According to another aspect of the invention, a dielectric member arranged in a radiating direction of electromagnetic waves radiated from an antenna element includes two or more dielectric layer portions each extending in a direction perpendicular to the radiating direction of the electromagnetic waves. The two or more dielectric layer portions are arranged at predetermined intervals in the radiating direction of the electromagnetic waves.

The dielectric layer portions may be coupled to each other with coupling portions made of a material similar to that of the dielectric layer portions.

The dielectric member may be formed in a meander shape by coupling the adjacent dielectric layer portions.

The dielectric layer portion may be formed in a plate shape.

The predetermined intervals may be ¼ wavelength or less of the electromagnetic waves radiated from the antenna element.

### BRIEF DESCRIPTION OF THE DRAWINGS

The present disclosure is illustrated by way of example and not by way of limitation in the figures of the accompanying drawings, in which the like reference numerals indicate like elements and in which:

FIG. 1 is a cross-sectional view showing a structure of a dielectric antenna according to Embodiment 1 of the present invention;

FIG. 2 is a cross-sectional view showing a modified example of the dielectric antenna according to Embodiment 1;

FIGS. 3A and 3B are schematic views illustrating configurations of the dielectric antenna of Embodiment 1 and a conventional dielectric antenna compared in a simulation shown in FIG. 4;

FIG. 4 is a graph showing simulation results that show directivities of vertical polarized waves and horizontal polarized waves of the dielectric antennas shown in FIGS. 3A and 3B;

FIGS. 5A, 5B, and 5C are schematic views illustrating configurations of the dielectric antennas of Embodiment 1 compared in another simulation shown in FIG. 6;

FIG. 6 is a graph showing simulation results that show directivities of vertical polarized waves and horizontal polarized waves of the dielectric antennas shown in FIGS. 5A, 5B, and 5C;

FIG. 7 is a cross-sectional view showing a modified example of the dielectric antenna according to Embodiment 1;

FIG. 8 is a cross-sectional view showing another modified example of the dielectric antenna according to Embodiment 1;

FIG. 9 is a cross-sectional view showing a structure of a dielectric antenna according to Embodiment 2 of the present invention;

FIGS. 10A, 10B, and 10C are cross-sectional views showing modified examples of the dielectric antenna according to Embodiment 2;

FIGS. 11A, 11B, and 11C are schematic views illustrating configurations of the dielectric antennas according to Embodiment 2;

FIG. 12 is a graph showing simulation results that show directivities of vertical polarized waves and horizontal polarized waves of the dielectric antennas shown in FIGS. 11A, 11B, and 11C;

FIG. 13 is a cross-sectional view showing a structure of another dielectric antenna according to Embodiment 3 of the present invention;

FIG. 14 is a graph showing simulation results illustrating effects of the dielectric antenna according to Embodiment 3;

FIG. 15 is a cross-sectional view showing a structure of another dielectric antenna according to Embodiment 4 of the present invention; and

FIG. 16 is a graph showing simulation results illustrating effects of the dielectric antenna according to Embodiment 4.

### DETAILED DESCRIPTION

### Embodiment 1

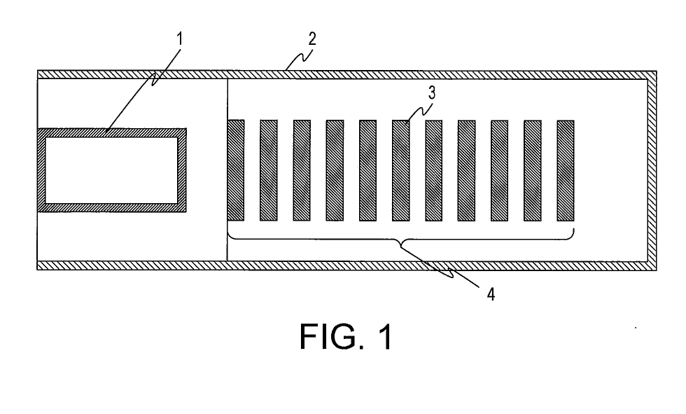

Hereinbelow, a dielectric antenna according to Embodiment 1 of the present invention is explained. FIG. 1 is a cross-sectional view showing a structure of the dielectric antenna of this embodiment. As shown in FIG. 1, the dielectric antenna includes an antenna element 1, an antenna case 2, and two or more dielectric layers 3. Note that an area where the two or more dielectric layers 3 are arranged is referred to as a “dielectric area 4.”

The antenna element 1 functions as a radiator for radiating electromagnetic waves at a predetermined frequency in a predetermined direction. Note that the antenna element 1 shown in FIG. 1 is a waveguide-type slot array antenna, which radiates electromagnetic waves to the right in the illustration from a slot provided in the waveguide.

The antenna case 2 is a case for covering the antenna element 1 and the two or more dielectric layers 3. Because the antenna case 2 affects to the electromagnetic waves radiated from the antenna element 1, the antenna case 2 is designed so as to have a low loss. In addition, in consideration of the influences of the electromagnetic waves radiated from the antenna element 1 to the directivity characteristics, a dielectric constant and shape of the antenna case 2 are designed together with the two or more dielectric layers 3 described in detail later.

Generally, antennas used for radar devices have directivity in a determined direction, and the antenna is rotated horizontally to repeat transmission and reception of signals, and thereby acquiring search signals of all directions. Because the antenna for the radar device is typically used outdoors, roles are required for the antenna case 2, such as reducing resistance against winds and protecting the antenna element 1 from rain and snow. Therefore, a material such as an AES resin is used for the antenna case 2, which is easy to be processed, and has a high environmental tolerance and a comparatively low dielectric loss.

The dielectric area 4 is an area in which the two or more dielectric layers 3 extending in a direction perpendicular to the radiating direction of the electromagnetic waves are provided, and is arranged in the radiating direction of the electromagnetic waves radiated from the antenna element 1. The dielectric area 4 acts on the electromagnetic waves radiated from the antenna element 1 to control the directivity of the electromagnetic waves radiated from the antenna element 1. By designing optimally the antenna case 2 and the dielectric area 4, beam forming of the electromagnetic waves radiated from the antenna element 1 is realized and the dielectric antenna can acquire desired directivity characteristics.

The dielectric layers 3 constituting the dielectric area 4 are each a plate-shaped dielectric extending in a direction perpendicular to the radiating direction of the electromagnetic waves, and they are arranged at predetermined intervals in the radiating direction of the electromagnetic waves. The dielectric layers 3 formed in layers and gaps (air layer) formed between the dielectric layers 3 integrally act on the electromagnetic waves radiated from the antenna element 1 to form a desired beam pattern.

The predetermined intervals at which the dielectric layers 3 are arranged are intervals such that the adjacent dielectric layers 3 with respect to the electromagnetic waves radiated from the antenna element act mutually without separately and independently. Therefore, the predetermined intervals at which the dielectric layers 3 are arranged may be desired to be ¼ wavelength or less of the electromagnetic waves radiated from the antenna element 1.

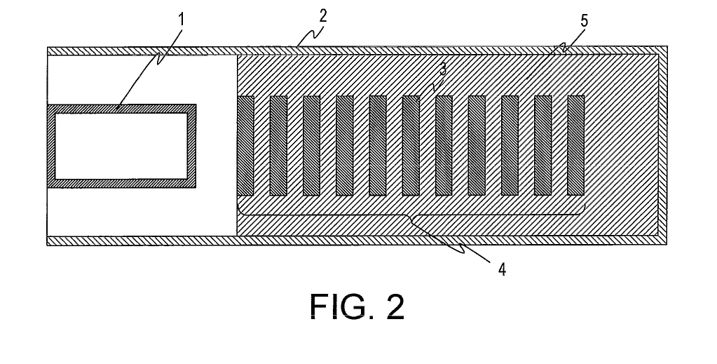

FIG. 2 is a cross-sectional view showing a modified example of the dielectric antenna according to Embodiment 1. As shown in FIG. 2, a support member 5 for supporting the two or more dielectric layers 3 may be arranged as a fixation of the dielectric layers 3. The support member 5 may be a material having a dielectric constant which does not affect the directivity of the electromagnetic waves radiated from the antenna element 1 and, thus, a dielectric material having a dielectric constant close to air may be selected.

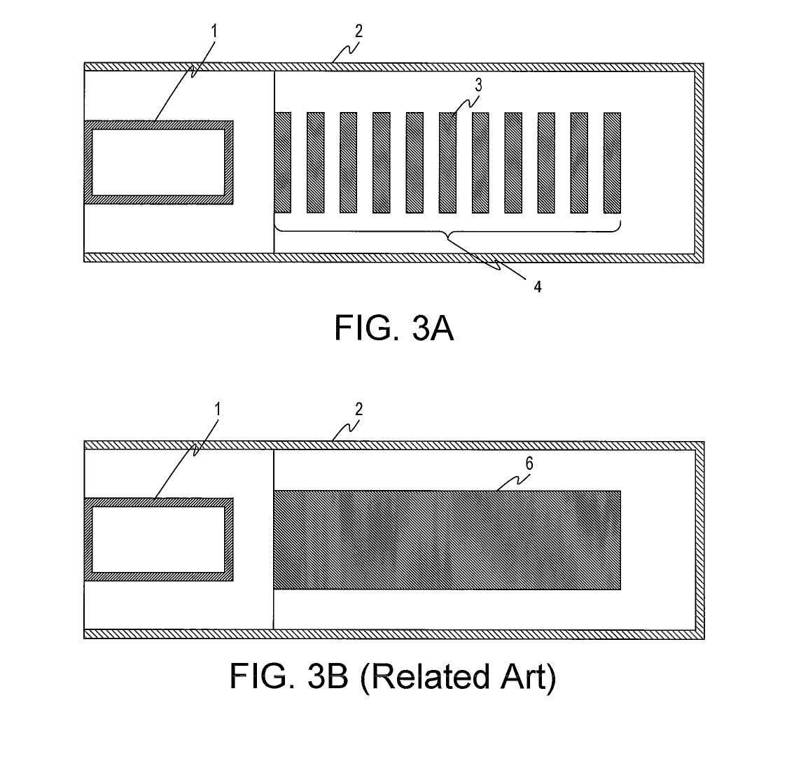

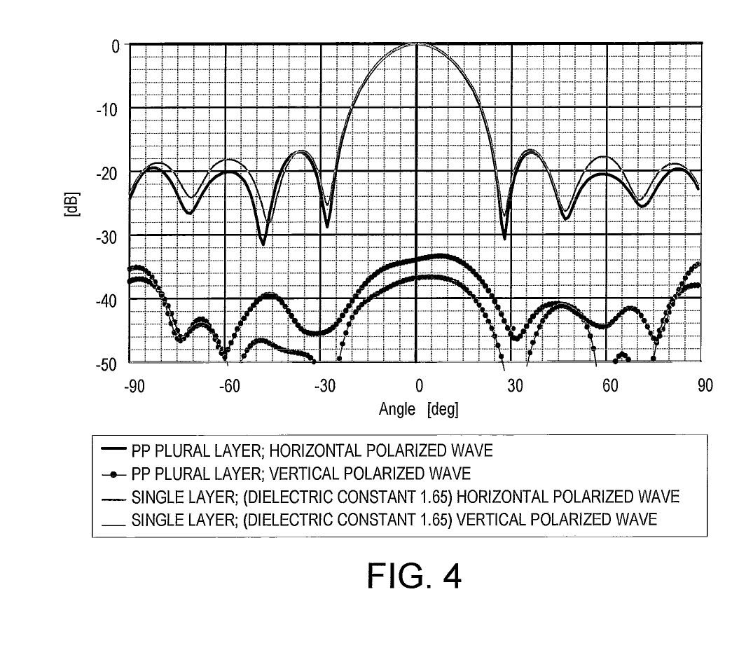

Next, an operation of the dielectric area 4 given to the electromagnetic waves radiated from the antenna element 1 is particularly explained referring to FIGS. 3A and 4. FIGS. 3A and 3B are schematic views illustrating configurations of the dielectric antenna compared in a simulation shown in FIG. 4, where FIG. 3A shows the dielectric antenna according to Embodiment 1 and FIG. 3B shows a conventional dielectric antenna.

The dielectric antenna of this embodiment shown in FIG. 3A uses polypropylene (PP) having a dielectric constant of approximately 2.3 as the dielectrics. The dielectrics are arranged to have intervals of ¼ wavelength or less of the electromagnetic waves radiated from the antenna element 1 through the two or more dielectric layers, respectively, so that a volume ratio of the dielectrics and air in the space (dielectric area 4) where the two or more plate-shaped dielectric layers 3 are arranged is set to substantially 1:1.

On the other hand, the conventional dielectric antenna shown in FIG. 3B is a dielectric antenna having the space (dielectric area 4) of the same size as the space where the two or more dielectric layers 3 the dielectric antenna of this embodiment shown in FIG. 3A are arranged. However, in the configuration of FIG. 3B, a dielectric having a dielectric constant of approximately 1.65 is arranged in the space.

FIG. 4 is a graph showing simulation results that show directivities of vertical polarized waves and horizontal polarized waves of the dielectric antennas shown in FIGS. 3A and 3B. As shown in FIG. 4, the directivity characteristics of the dielectric antennas shown in FIGS. 3A and 3B are substantially the same even though the dielectric constants are different from each other.

In other words, even when air and the dielectric are not distributed uniformly like the foamed dielectric, an effective dielectric constant of the dielectric area 4 where the two or more dielectric layers 3 are arranged can be changed by arranging the dielectric layers 3 at the predetermined intervals. The effective dielectric constant of this dielectric area 4 can be changed according to a volume ratio with the two or more dielectric layers 3 and the gaps (air layer) between the dielectric layers 3.

Hereinbelow, a method of deriving the effective dielectric constant of the dielectric area 4 is explained. Assuming that the volume ratio of the dielectrics and air is 1:x, the effective dielectric constant ∈ᵣ' can be derived by Equation 1, since the dielectric constant of air is 1.

$${ɛ}_{r}^{′} = \frac{{ɛ}_{r} + x}{1 + x} \qquad ( 1 )$$

### Here,

∈ᵣ: dielectric constant of dielectrics; and
∈ᵣ′: effective dielectric constant (average dielectric constant).

Therefore, if the effective dielectric constant ∈ᵣ′ required for design and the dielectric constant ∈ᵣ of the dielectric to be used are determined, the volume ratio x of the dielectric and air can be derived from Equation 2.

$$x = \frac{{ɛ}_{r} - {ɛ}_{r}^{′}}{{ɛ}_{r}^{′} - 1} \qquad ( 2 )$$

However, the intervals of the two or more dielectric layers 4 arranged in the dielectric area 4 are necessary to be ¼ wavelength or less of the electromagnetic waves radiated from the antenna element 1.

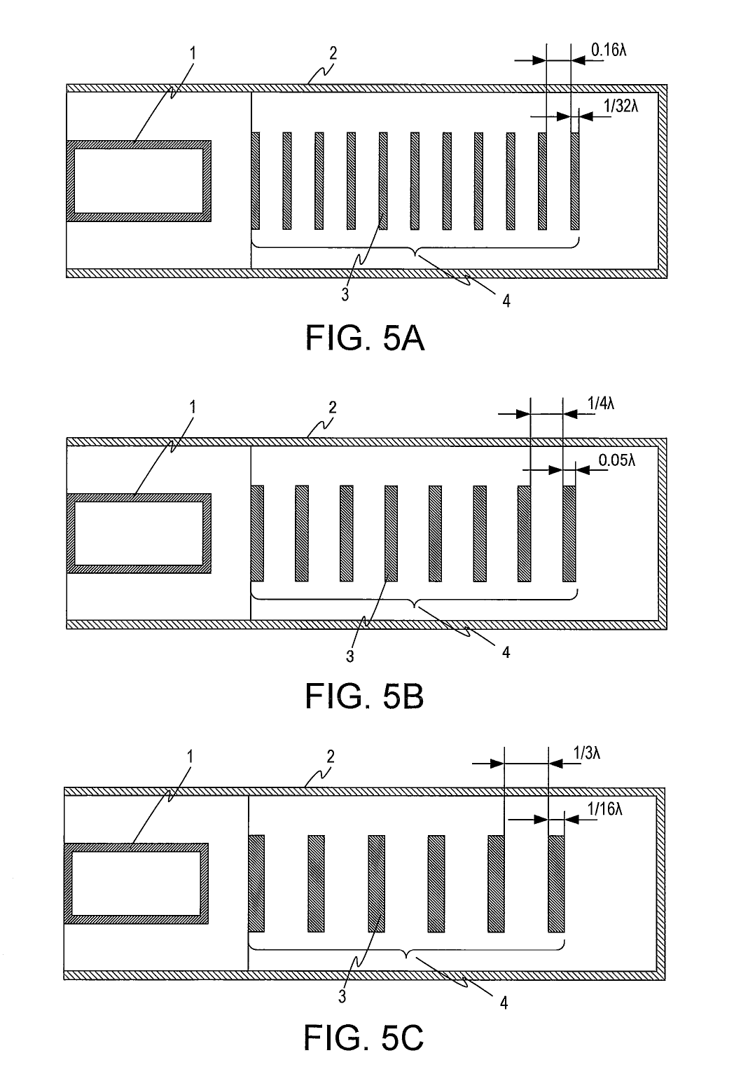

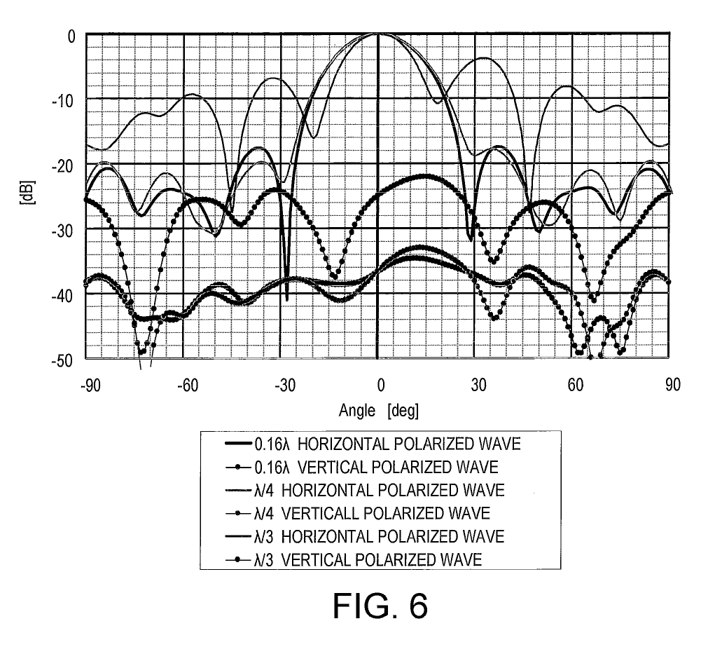

Hereinbelow, the intervals of the adjacent dielectric layers 4 are particularly explained referring to FIGS. 5A, 5B, and 5C, and FIG. 6. FIGS. 5A, 5B, and 5C are schematic views illustrating configurations of the dielectric antennas compared in a simulation shown in FIG. 6. In FIGS. 5A, 5B, and 5C, the dielectric layers 3 having a dielectric constant of approximately 5 are arranged in substantially the same dielectric areas 4, and intervals of each dielectric layer 3 in the dielectric area 4 is set to approximately 0.16λ, ¼λ, and ⅓λ of the electromagnetic waves radiated from the antenna element 1, respectively. Note that thicknesses of the dielectric layers in FIGS. 5A, 5B, and 5C are set based on Equations 1 and 2 described above so that the effective dielectric constants produced by the respective dielectric areas 4 where the dielectric layers 3 having the different thickness are arranged are substantially the same for all of the dielectric layers.

FIG. 6 is a graph showing the simulation results that show the directivities of vertical polarized waves and horizontal polarized waves of the dielectric antennas shown in FIGS. 5A, 5B, and 5C. As shown in FIG. 6, in the case where the intervals of the dielectric layers 3 are approximately 0.16λ and ¼λ, substantially the same directivity characteristics can be acquired; however, in the case where the intervals of the dielectric layers 3 are approximately ⅓λ, the directivity characteristics are different.

Thus, if the intervals of the dielectric layers 3 are too sparse (large), the dielectric area 4 where the two or more dielectric layers 3 are arranged no longer acts integrally on the electromagnetic waves radiated from the antenna element 1. Therefore, the dielectric layers 3 arranged in the dielectric area 4 and the gaps (air layers) between the dielectric layers 3 will act individually on the electromagnetic waves radiated from the antenna element 1.

For this reason, the predetermined intervals at which the dielectric layers 3 are arranged need to be intervals which act mutually on the electromagnetic waves radiated from the antenna element. Therefore, the intervals may be desirable to be approximately ¼λ or less of the electromagnetic waves radiated from the antenna element 1.

Note that, although Embodiment 1 is explained as an example in which the two or more plate-shaped dielectric layers 3 are formed in the dielectric area 4, the effective dielectric constant of the dielectric area 4 may be changed freely by adjusting the shape and intervals of the dielectric layers 3 arranged in the dielectric area 4.

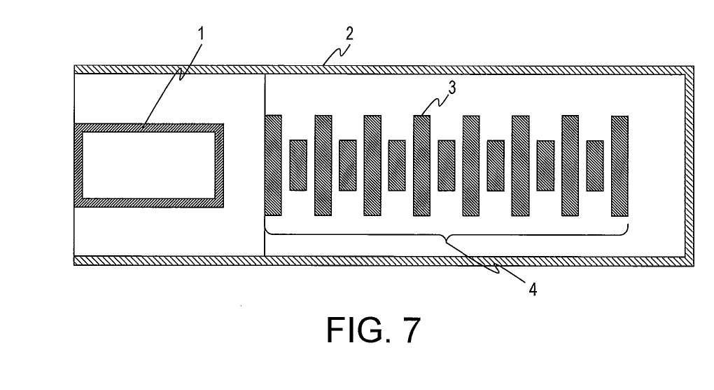

For example, as shown in FIG. 7, in the radiating direction of the electromagnetic waves from the antenna element 1, the intervals of the dielectric layers 3 in the dielectric area 4 may be set densely in the center section and sparsely in the outside section. Thus, the effective dielectric constant in the dielectric area 4 can be changed from the center section toward the outside section from a higher dielectric constant to a lower dielectric constant, respectively.

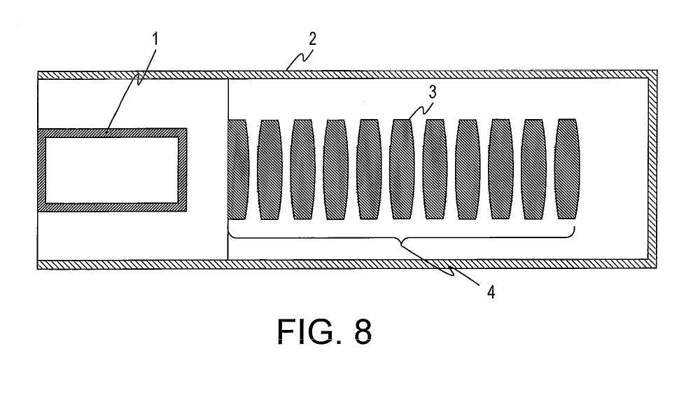

Alternatively, as shown in FIG. 8, the shape of the plate-shaped dielectric layers 3 may be thick in the center section and thin in the outside section in the radiating direction of the electromagnetic waves from the antenna element 1. Thus, similarly, the effective dielectric constant in the dielectric area 4 can be changed from the center section toward the outside section from a higher dielectric constant to a lower dielectric constant, respectively.

As described above, according to the dielectric antennas of this embodiment, effects similar to the configuration provided with the dielectric of a desired dielectric constant in the dielectric area 4 can be acquired by adjusting the shape and intervals of the dielectric layers 3.

### Embodiment 2

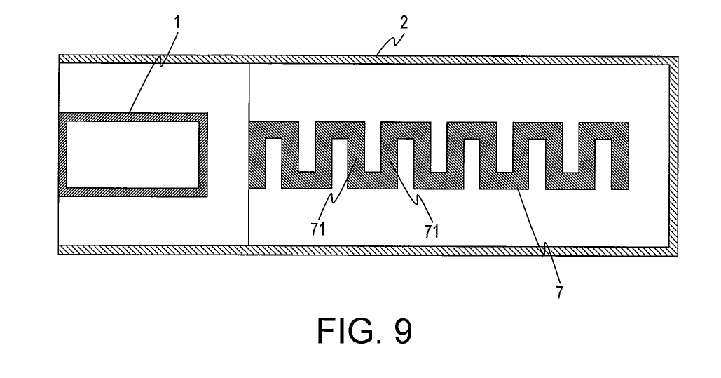

Next, a dielectric antenna of another embodiment of the invention is explained. FIG. 9 is a cross-sectional view showing the dielectric antenna of this embodiment. The dielectric antenna of this embodiment is different from the dielectric antenna of Embodiment 1 described above in that a meander-shaped dielectric 7 is arranged instead of the two or more dielectric layers 3. Therefore, like components are denoted with like reference numerals, and explanation thereof is omitted in this embodiment.

The dielectric 7 is arranged in the radiating direction of the electromagnetic waves radiated from the antenna element 1, and is a dielectric of a meander shape extending in the radiating direction of the electromagnetic waves radiated from the antenna element 1.

The meander-shaped dielectric 7 intermittently connects the ends of the dielectric layers 3 of Embodiment 1, and two or more layered dielectrics 71 extending in a direction perpendicular to the radiating direction of the electromagnetic waves are arranged at predetermined intervals in the radiating direction of the electromagnetic waves.

Similar to the dielectric antennas of Embodiment 1, in the meander-shaped dielectric 7, the two or more layered dielectrics 71 extending in the direction perpendicular to the radiating direction of the electromagnetic waves and gaps formed between the layered dielectrics 71 acts integrally on the electromagnetic waves radiated from the antenna element 1 to form a desired beam pattern. Note that, similar to the dielectric antennas of Embodiment 1, the predetermined intervals at which the layered dielectrics 71 are arranged may be desirable to be at least set to intervals of ¼ wavelength or less of the electromagnetic waves radiated from the antenna element 1.

Similar to Embodiment 1, in the meander-shaped dielectric 7, by adjusting the thickness and intervals of the dielectrics constituting the meander shape, effects similar to the configuration in which dielectrics of a desired dielectric constant are arranged in the space where the dielectric 7 is arranged can be acquired.

The meander-shaped dielectric 7 may be simply manufactured by extrusion molding etc. Therefore, compared with the case where the plate-shaped dielectric layers 3 are arranged parallely like the dielectric antennas described in Embodiment 1, positioning of each dielectric layer is easy, and the support member for individually supporting the two or more dielectric layers will be unnecessary. The meander-shaped dielectric 7 may be manufactured at low cost, and may have an advantage in which its manufacturing errors will be smaller.

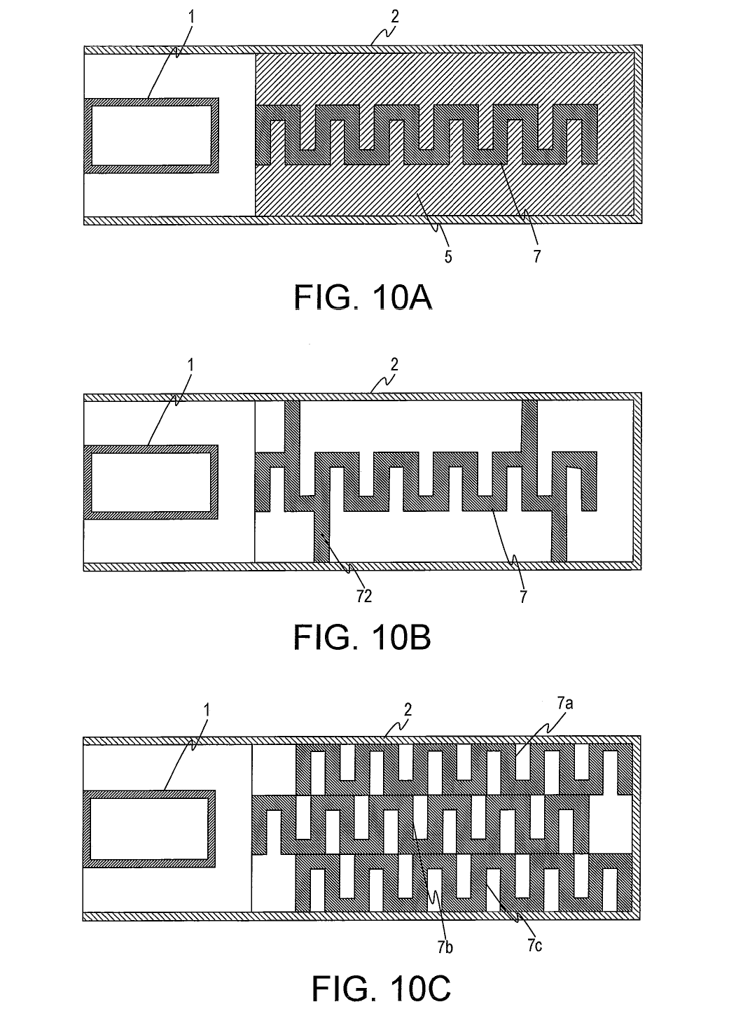

FIGS. 10A, 10B, and 10C are cross-sectional views showing modified examples of the dielectric antenna of Embodiment 2. For example, as shown in FIG. 10A, as a fixation of the meander-shaped dielectric 7, a support member 5 for supporting the meander-shaped dielectric 7 from above and below of the meander-shaped dielectric 7 may be arranged. This support member 5 may be made of a material having a dielectric constant that does not affect to the directivity characteristics of the electromagnetic waves radiated from the antenna element 1 and, thus, a dielectric material having a low dielectric constant close to air may be selected.

Alternatively, as shown in FIG. 10B, support members 72 may be formed made by extending some of parts of the meander-shaped dielectric 7. In addition, by connecting the support members 72 with the antenna case 2, the meander-shaped dielectric 7 may be fixed to the antenna case. Alternatively, as shown in FIG. 10C, two or more meander-shaped dielectrics 7a, 7b, and 7c may be formed parallely, and the meander-shaped dielectrics 7a, 7b, and 7c may be configured to support mutually.

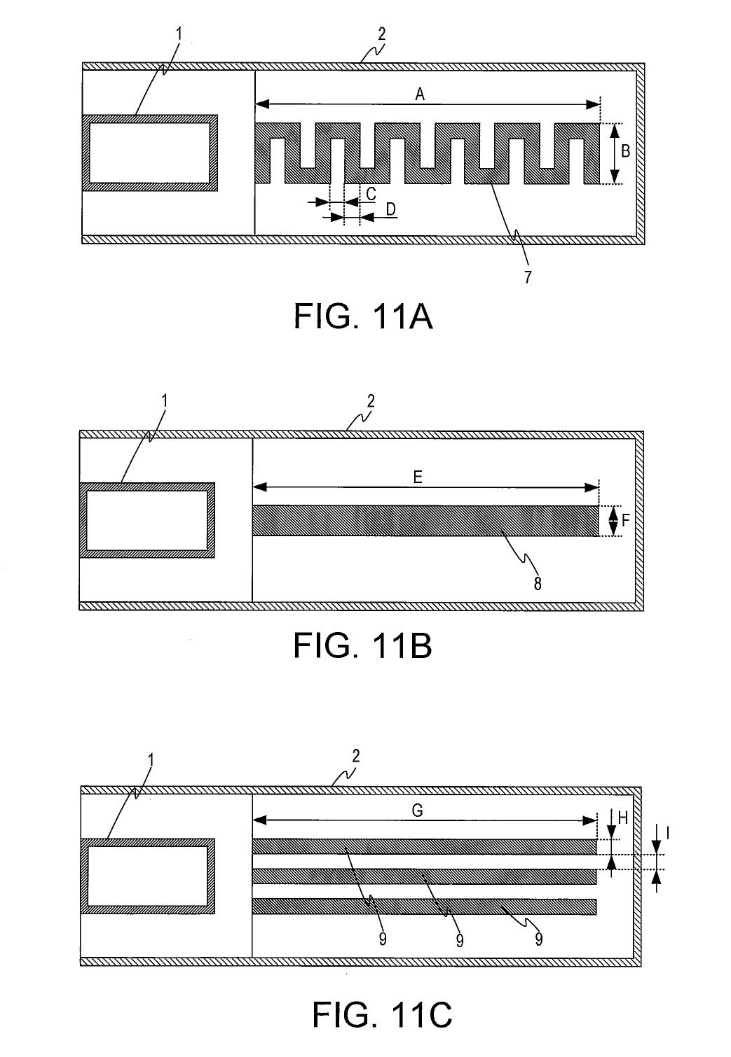

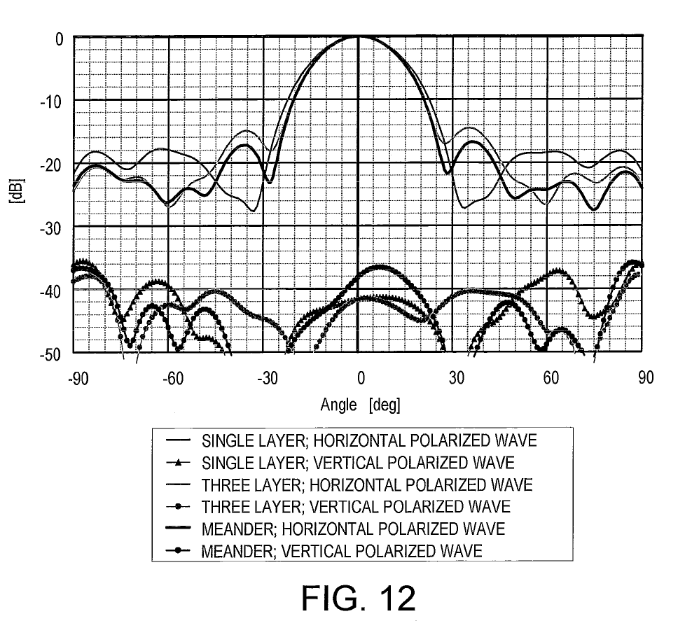

Next, effects of the dielectric antennas of Embodiment 2 are explained referring to FIGS. 11A, 11B, and 11C, and FIG. 12. FIGS. 11A, 11B, and 11C are schematic views illustrating the configurations of the dielectric antennas compared in a simulation shown in FIG. 12.

The meander-structured dielectric 7 shown in FIG. 11A is made of polypropylene (PP) having a dielectric constant of approximately 2.3, and has a shape of A=70 mm, B=14 mm, and C=D=2 mm, for example. The dielectric layer 8 shown in FIG. 11B is provided with a single layer of polypropylene (PP) having a dielectric constant of approximately 2.3, and has a shape of E=70 mm and F=6 mm, for example. The dielectric layer 9 shown in FIG. 11C is provided with three layers of polypropylene (PP) having a dielectric constant of approximately 2.3, and has a shape of G=70 mm and H=3 mm, for example, where intervals I of the dielectric layers 9 are set to 3 mm, for example.

FIG. 12 is simulation results that show directivities of vertical polarized waves and horizontal polarized waves of the dielectric antennas shown in FIGS. 11A, 11B, and 11C. Here, in this simulation, electromagnetic waves of approximately 9.4 GHz is generated from the antenna element 1, and the directivity characteristics of the electromagnetic waves radiated from the antenna are measured. The antenna case 2 used is made of an AES resin having 2 mm thickness for every case. Table 1 summarizes substantial characteristics of the simulation results shown in FIGS. 11A, 11B, and 11C.

TABLE 1

| | Vertical Beam Width | Vertical Side Lobe | Height |
|---|---|---|---|
| Model | [°] | Ratio [dB] | [mm] |
| Meander Shape | 24.1 | 16.8 | 34 |
| Single Layer | 25.8 | 18.2 | 34 |
| Three Layers | 23.8 | 14.6 | 34 |

As shown in Table 1, when the dielectric antennas of Embodiment 2 are compared with the dielectric antenna of the conventional single-layer model, it can be understood that the beam is narrowed to have a 1.7 degrees smaller beam width. Further, when the dielectric antennas of Embodiment 2 are compared with the dielectric antenna of the conventional three-layer model, it can be understood that the beam width is 0.3 degrees larger but the side lobe ratio is better by 2.2 dB.

### Embodiment 3

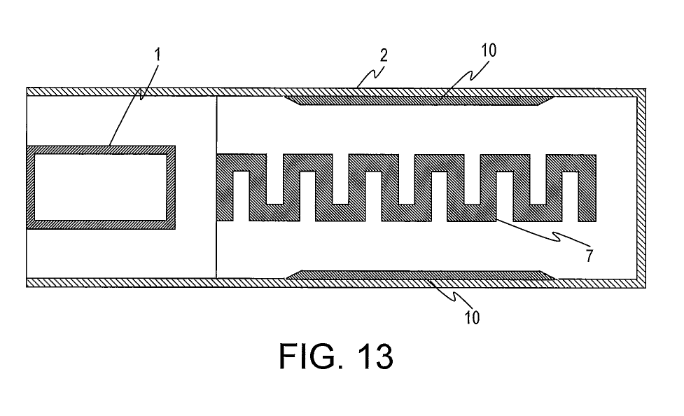

Next, a dielectric antenna according to Embodiment 3 of the invention is explained. FIG. 13 is a cross-sectional view showing a structure of the dielectric antenna according to Embodiment 3. The dielectric antenna of Embodiment 3 is different from the dielectric antennas of Embodiment 2 described above in that protrusions 10 are additionally provided. Therefore, like components are denoted with like reference numerals, and explanation is omitted in this embodiment.

The protrusions 10 are formed on a face substantially parallel to the radiating direction of the electromagnetic waves of the antenna case 2, and are made of a predetermined dielectric material. The protrusions 10 may be separately manufactured from the antenna case 2 and attached to the inner face of the antenna case 2. Alternatively, the protrusions 10 may be formed integrally with the antenna case 2 using the same or similar dielectric material as the antenna case 2.

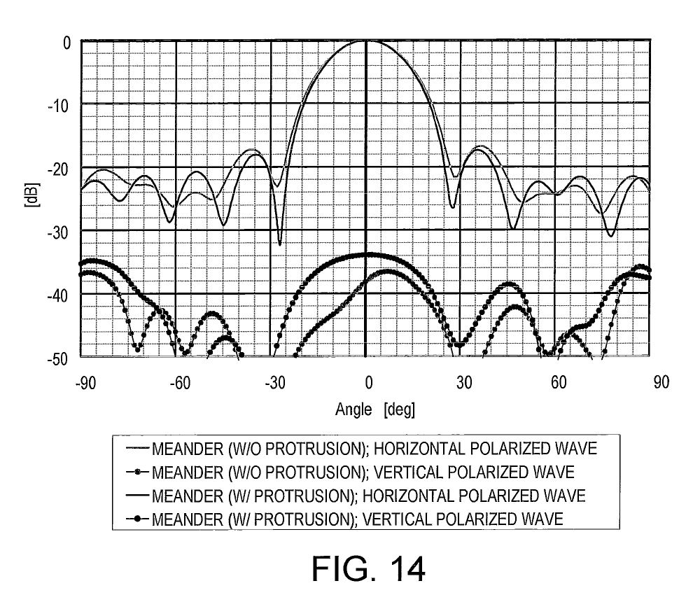

FIG. 14 shows simulation results of the dielectric antenna provided with the protrusions 10. Note that the configuration of this dielectric antenna is similar to the dielectric antenna shown in FIG. 11A. In addition, protrusions 10 having a thickness of 0.5 mm and a length of 50 mm are provided in the antenna case 2 forward of the antenna element 1. A material of the protrusions 10 is an AES resin as the same as the antenna case 2. Table 2 summarizes substantial characteristics of the simulation results shown in FIG. 14.

TABLE 2

| | Vertical Beam Width | Vertical Side Lobe | Height |
|---|---|---|---|
| Model | [°] | Ratio [dB] | [mm] |
| w/ protrusions | 24.1 | 16.8 | 34 |
| w/o protrusions | 23.1 | 17.4 | 34 |

As shown in Table 2, because in the dielectric antenna of Embodiment 3, the protrusions 10 are additionally provided to the dielectric antenna of Embodiment 2, the beam width was reduced by approximately 1.0 degree and the side lobe ratio was improved by approximately 0.6 dB. Thus, the directivity characteristics of the antenna can be improved by providing the protrusions 10.

### Embodiment 4

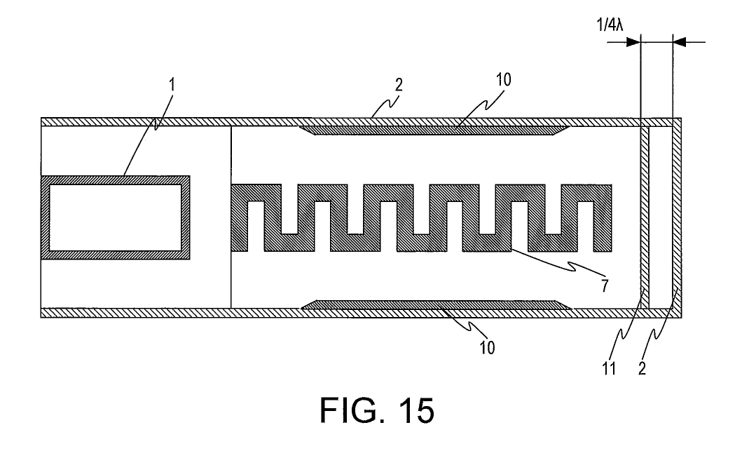

Next, the dielectric antenna according to Embodiment 4 of the invention is explained. FIG. 15 is a cross-sectional view showing a structure of the dielectric antenna of Embodiment 4. Note that the dielectric antenna of Embodiment 4 is different from the dielectric antenna of Embodiment 3 described above in that the antenna case 2 of the dielectric antenna of Embodiment 3 has a double opening. Therefore, like components are denoted with like reference numerals, and explanation is omitted in this embodiment.

A dielectric wall 11 is arranged inside the antenna case 2, substantially parallel to a face of the antenna case 2 where the electromagnetic waves radiated from the antenna element 1 intersects perpendicularly. The face of the antenna case 2 and the dielectric wall 11 are arranged so as to intervene an air layer therebetween so that they are separated from each other substantially by ¼λ wavelength to form the double opening. Thus, reflected waves of the electromagnetic waves radiated from the antenna element 1 on the dielectric wall 11 and reflected waves of the electromagnetic waves radiated from the antenna element 1 on the antenna case 2 cancel out for each other to suppress the radiation of the electromagnetic waves to the rear of the dielectric antenna.

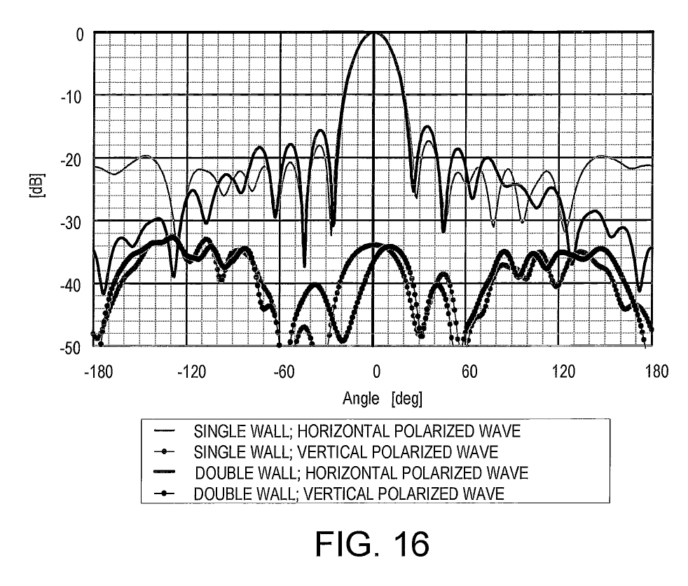

FIG. 16 shows simulation results of the dielectric antenna provided with the dielectric wall 11. Note that configuration of the dielectric antenna other than described above is similar to the dielectric antenna used in the simulation of FIG. 14. A thickness of the dielectric wall 11 is 1 mm, and a material used is an AES resin which is the same as the antenna case 2, for example.

As shown in FIG. 16, the dielectric antenna of Embodiment 3 in which the dielectric wall 11 is not provided has slightly lower side lobes comparing with the dielectric antenna of Embodiment 4 in which the dielectric wall 11 is provided. However, the former has reflected waves to the rear, which is referred to as “back lobes,” are as high as about −20 dB. This may be caused by the electromagnetic waves from the antenna element 1 which are reflected on the antenna case 2.

On the other hand, in the dielectric antenna of Embodiment 4 in which the dielectric wall 11 is provided, the reflected waves on the dielectric wall 11 and the reflected waves on the antenna case 2 cancel out for each other to significantly reduce the back lobes.

In the foregoing specification, specific embodiments of the present invention have been described. However, one of ordinary skill in the art appreciates that various modified examples and changes can be made without departing from the scope of the present invention as set forth in the claims below. Accordingly, the specification and figures are to be regarded in an illustrative rather than a restrictive sense, and all such modified examples are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims, including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined integrally or more unless explicitly stated otherwise herein. The terms “substantially,” “essentially,” “approximately,” “approximately” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A dielectric antenna, comprising:
an antenna element for radiating electromagnetic waves at a predetermined frequency in a predetermined direction; and
a dielectric member arranged in the radiating direction of the electromagnetic waves radiated from the antenna element, the dielectric member including two or more dielectric layer portions each extending in a direction perpendicular to the radiating direction of the electromagnetic waves, and the two or more dielectric layer portions being arranged at predetermined intervals in the radiating direction of the electromagnetic waves.

2. The dielectric antenna of claim 1, wherein the dielectric layer portions are coupled to each other with coupling portions made of a material similar to that of the dielectric layer portions.

3. The dielectric antenna of claim 2, wherein the dielectric member is formed in a meander shape by coupling the adjacent dielectric layer portions.

4. The dielectric antenna of claim 1, wherein the dielectric layer portion is formed in a plate shape.

5. The dielectric antenna of claim 1, wherein the predetermined intervals are ¼ wavelength or less of the electromagnetic waves radiated from the antenna element.

6. The dielectric antenna of claim 1, further comprising an antenna case made of a dielectric material;
wherein beam forming of the electromagnetic waves radiated from the antenna element is performed by the two or more dielectric layer portions and the antenna case.

7. The dielectric antenna of claim 6, wherein a protrusion is provided in a face of the antenna case substantially parallel to the radiating direction of the electromagnetic waves.

8. The dielectric antenna of claim 6, a dielectric wall is provided inside the antenna case, substantially parallel to a face of the antenna case at which the electromagnetic waves radiated from the antenna element intersect perpendicularly, and at a position that is separated from the face of the antenna case by substantially ¼ wavelength.

9. The dielectric antenna of claim 1, further comprising a support member for supporting the two or more dielectric layer portions.

10. A dielectric antenna, comprising:
an antenna element for radiating electromagnetic waves at a predetermined frequency in a predetermined direction; and
a dielectric area where dielectrics are arranged in the radiating direction so as to be spaced from each other at intervals of ¼ wavelength or less of the electromagnetic waves radiated from the antenna element;
wherein an effective dielectric constant of the dielectric area that acts on the electromagnetic waves radiated from the antenna is determined based on a dielectric constant of the dielectrics arranged in the dielectric area and a volume of the dielectrics in the dielectric area.

11. A dielectric member arranged in a radiating direction of electromagnetic waves radiated from an antenna element, comprising two or more dielectric layer portions each extending in a direction perpendicular to the radiating direction of the electromagnetic waves, the two or more dielectric layer portions being arranged at predetermined intervals in the radiating direction of the electromagnetic waves.

12. The dielectric member of claim 11, wherein the dielectric layer portions are coupled to each other with coupling portions made of a material similar to that of the dielectric layer portions.

13. The dielectric member of claim 12, wherein the dielectric member is formed in a meander shape by coupling the adjacent dielectric layer portions.

14. The dielectric member of claim 11, wherein the dielectric layer portion is formed in a plate shape.

15. The dielectric member of claim 12, wherein the predetermined intervals are ¼ wavelength or less of the electromagnetic waves radiated from the antenna element.
